(19) United States
(12) Patent Application Publication
(10) Pub. No.: US 2013/0207982 A1
(43) Pub. Date: Aug. 15, 2013

(54) Method and System for Rendering an Application View on a Portable Communication Device

(71) Applicants: Marko Lehtimäki, Helsinki (FI); Antti Hannula, Helsinki (FI); Henri Vähäkainu, Nurmijarvi (FI)

(72) Inventors: Marko Lehtimäki, Helsinki (FI); Antti Hannula, Helsinki (FI); Henri Vähäkainu, Nurmijarvi (FI)

(73) Assignee: APPGYVER OY, Helsinki (FI)

(21) Appl. No.: 13/372,756

(22) Filed: Feb. 14, 2012

(51) Int. Cl. G06T 13/00

(52) U.S. Cl. 345/473

(57) ABSTRACT

Disclosed are a method and a system for rendering an application view on a portable communication device. The method includes a step 102 of capturing a screenshot of a current view of the application and a step 104 of loading a subsequent view of the application in the background. The method is characterized by transitioning from the current view to the subsequent view when the subsequent view is substantially loaded at step 104. The screenshot of the current view is displayed until the subsequent view is substantially loaded. The method and the system disclosed herein allow a user to navigate across different views of the application without noticeable lag.

### FIELD OF THE INVENTION

The present invention relates to methods and systems for rendering one or more application views on a portable communication device, in particular to a method and a system which allows a user to navigate across different views of an application without noticeable lag. Moreover, the present invention relates to software products recorded on machine readable data storage media, wherein the software products are executable on computing hardware for implementing aforesaid methods.

### BACKGROUND OF THE INVENTION

Over the years, portable communication devices such as mobile phones, tablet computers, Personal Digital Assistants (PDAs), smartphones, and so forth have become an integral part of everyday life. These portable communication devices are no longer restricted to making and receiving mobile calls but are now designed to access the Internet over data connections. To cater for the data transfer needs that users of these portable communication devices demand, network service providers now need to support data connections via the mobile network in addition to supporting voice calls. Considering the large number of users of the mobile network, the bandwidth and speeds that mobile service providers can provide to each user is minimal.

As a result of the relatively slower speeds associated with data transfer over mobile networks, simple tasks on a portable communication device such as navigating through different pages of a website may become frustrating. For example, when a user clicks a particular link on a current web page, a request is sent to a server hosting the web page and subsequently content corresponding to the clicked link is received at the portable communication device. Due to a slow network coupling the server to the device, there is usually a time lag of a few seconds between when the user clicks the link and when the content is displayed on the device. During this time lag, the current web page is cleared and a blank screen or a “loading” screen is displayed by the device to the user. This blank page causes a problem of unpleasant flickering on the portable communication device, thus reducing usability for the user. In some cases, frequently viewed web pages may be cached on the portable communication device and these web pages may be rendered from the cached copy. However, even in such cases the problem of a flicker is prevalent as the current web page is cleared and a blank screen is displayed until the cached copy of a web page is rendered. Similarly, even if the portable communication device is connected to the Internet over relatively higher bandwidth connection, for example Wi-Fi, 3G or 4G network, transitioning from a current web page to a subsequent web page involves clearing the current web page and displaying a blank screen until the subsequent web page is loaded.

Thus, there is a need in the art for a method and a system which allow a user to navigate across different views of an application without noticeable lag.

### SUMMARY OF THE INVENTION

The present invention seeks to provide a method and a system which allow a user to navigate across different views of an application without noticeable time lag.

According to a first aspect of the present invention, there is provided a method of rendering an application view as defined in appended claim 1. The method includes capturing a screenshot of a current view of the application and loading a subsequent view of the application in the background. The method is characterized by transitioning from the current view to the subsequent view when the subsequent view is substantially loaded. The screenshot of the current view is displayed until the subsequent view is substantially loaded. As a result of the screenshot of the current view being displayed until the subsequent view is substantially loaded, there is no clearing of the current page until the subsequent page is loaded. This prevents unpleasant flickering on the portable communication device.

According to a second aspect of the present invention, there is provided a system for rendering an application view. The system includes an imaging module for capturing a screenshot of a current view of said application. The system also includes a processor for loading a subsequent view of the application, characterized by, the processor transitioning from the current view to the subsequent view when the subsequent view is substantially loaded, wherein the screenshot of the current view of the software application is displayed until the subsequent view is substantially loaded.

According to a third aspect of the present invention, there is provided a software product recorded on machine readable data storage media, characterized in that the software product is executable upon computing hardware for implementing a method pursuant to the first aspect of the invention.

It will be appreciated that features of the invention are susceptible to being combined in various combinations without departing from the scope of the invention as defined by the appended claims.

### DESCRIPTION OF THE DIAGRAMS

Embodiments of the present invention will now be described, by way of example only, with reference to the following diagrams wherein:

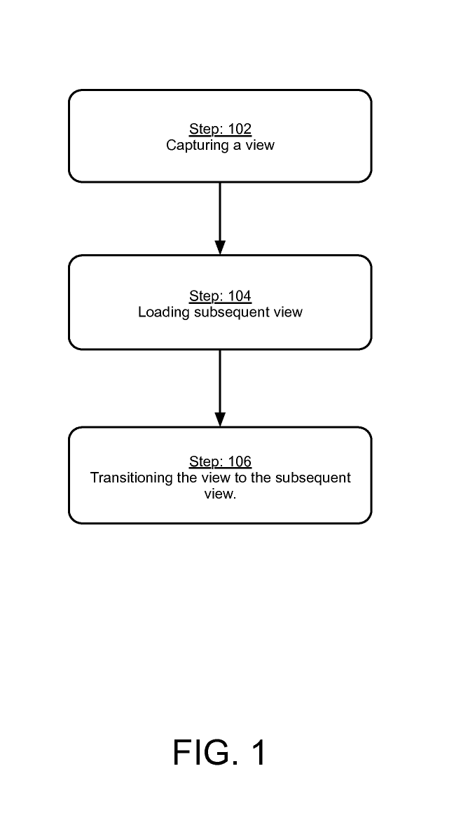

FIG. 1 is an illustration of a flow chart of a method of rendering an application view on a portable communication device.

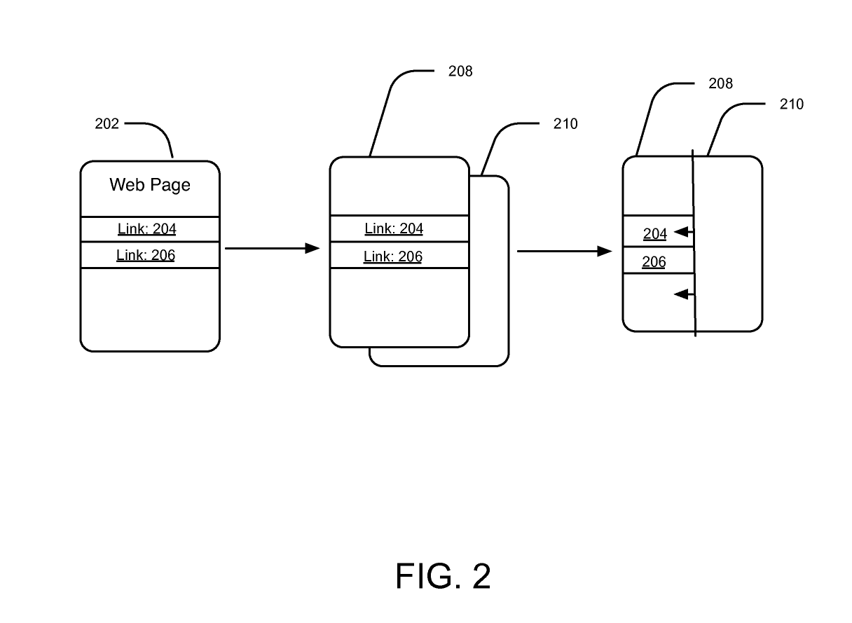

FIG. 2 is an illustration of a schematic representation of an exemplary embodiment of a method of rendering an application view on a portable communication device.

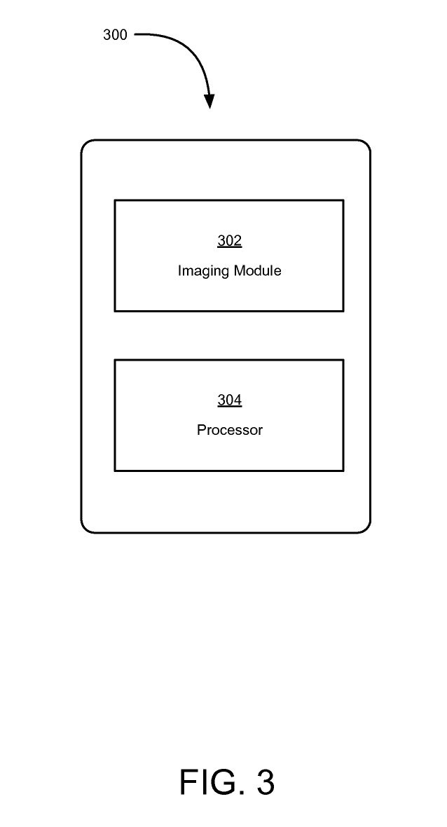

FIG. 3 is an illustration of a system for rendering an application view on a portable communication device.

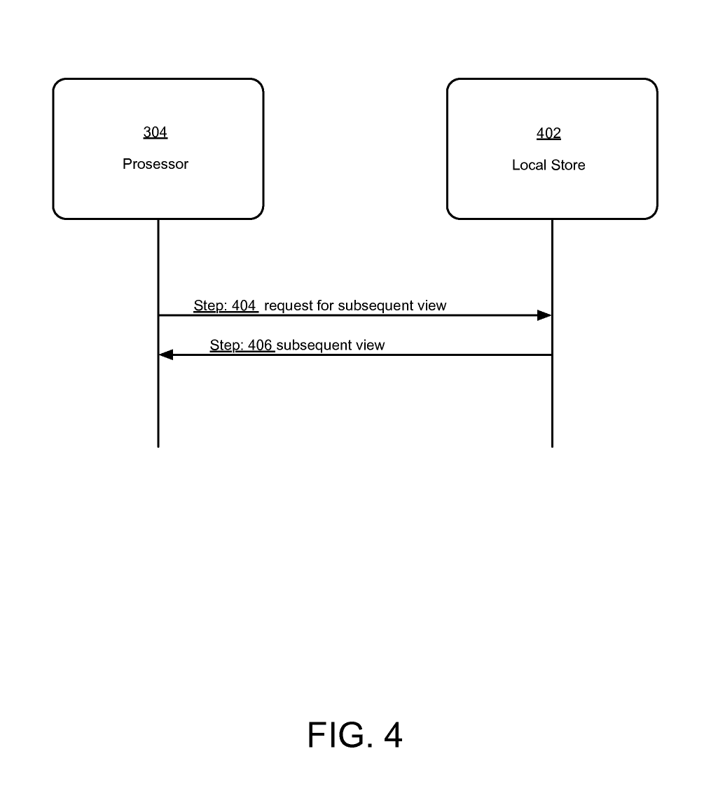

FIG. 4 is an illustration of a schematic representation depicting interaction between a processor and a local store to load a current view and a subsequent view of the application.

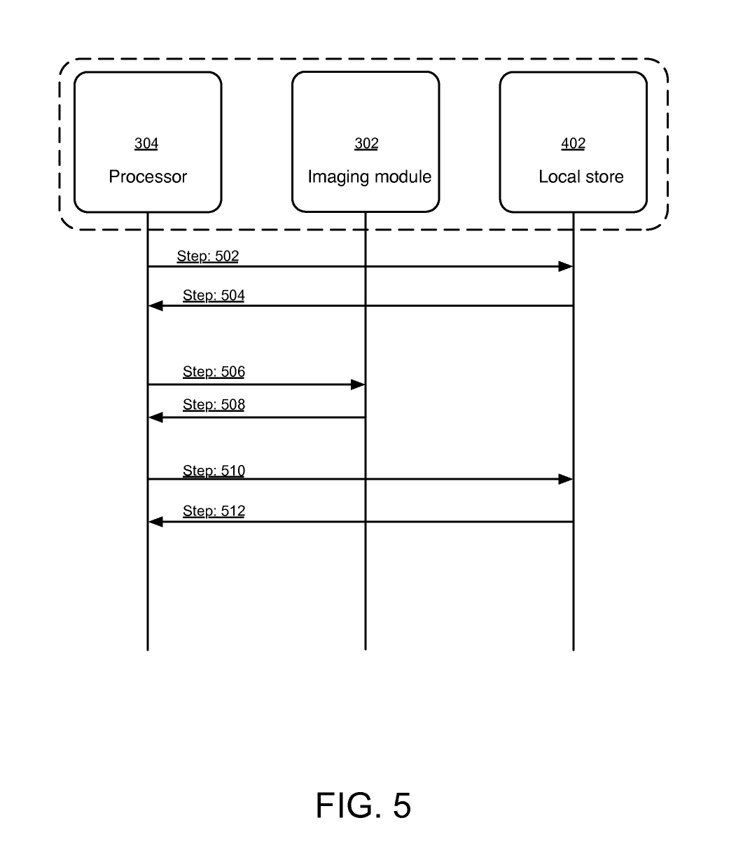

FIG. 5 is an illustration of an exemplary embodiment depicting interaction between a processor, an imaging module, and a local store to load a current view and a subsequent view of the application.

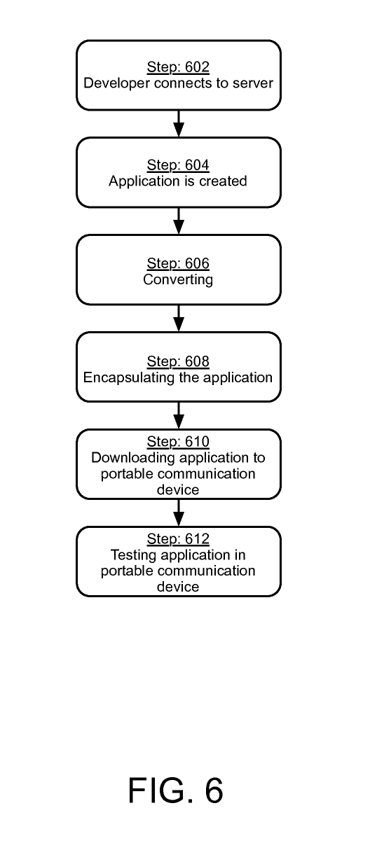

FIG. 6 is an illustration of a method of developing a software application for a portable communication device.

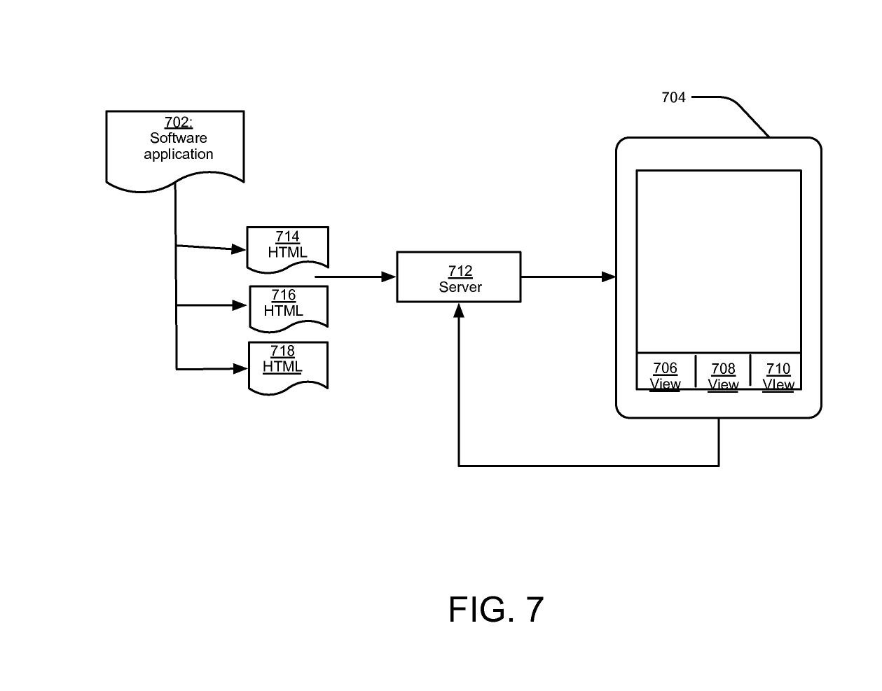

FIG. 7 is an illustration of a schematic representation of a method of developing a software application for a portable communication device.

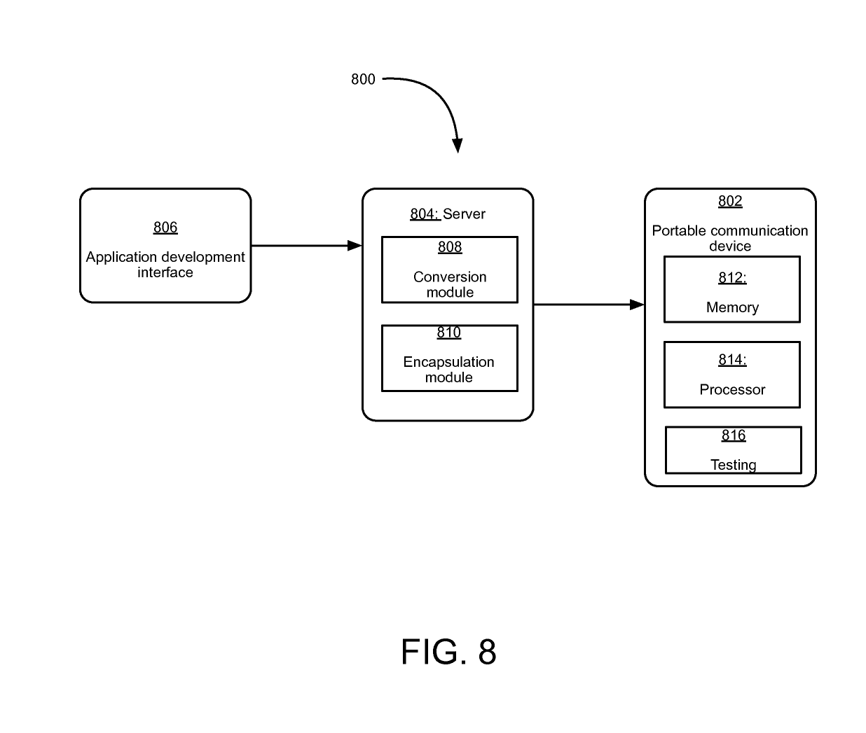

FIG. 8 is an illustration of an application development system for developing a software application for a portable communication device in communication with a server.

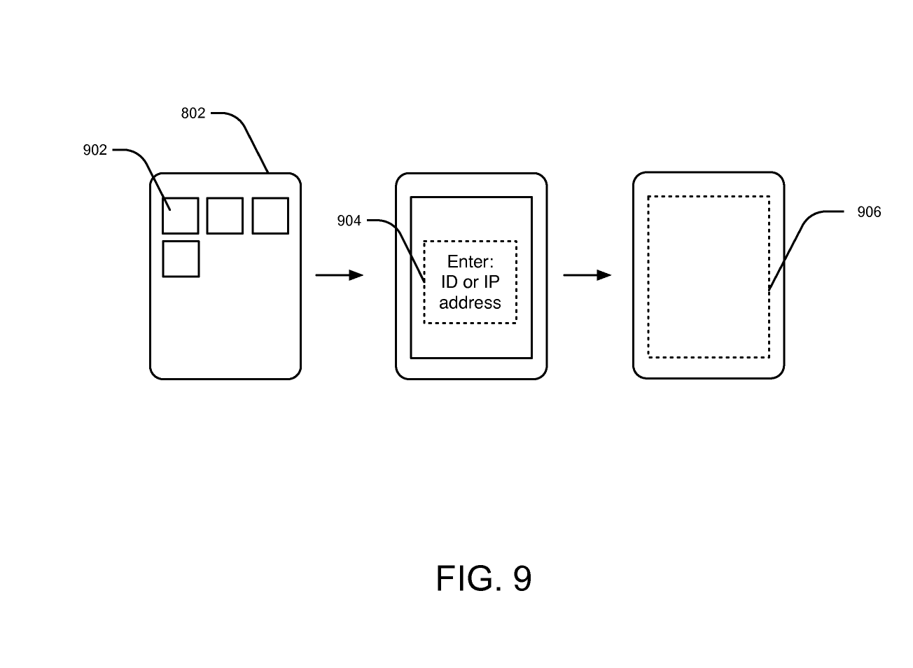

FIG. 9 is an illustration of a preview application associated with the portable communication device.

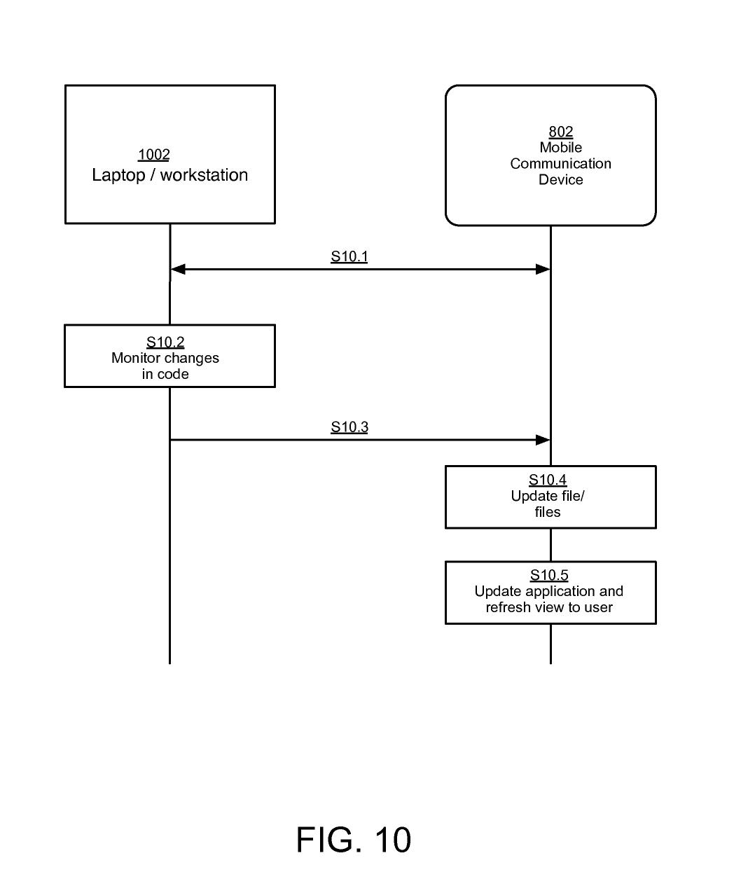

FIG. 10 is a flow chart illustrating some steps on updating software in a portable communication device.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS OF THE INVENTION

FIG. 1 is an illustration of a flow chart of a method of rendering an application view on a portable communication device. The portable communication device refers to a mobile phone or a smartphone. In a first step 102, a screenshot of a current view of an application is captured. The current view of the application corresponds to the view of the application currently displayed or being viewed on the portable communication device. In this case, a view of the application is associated with a state of the application. Capturing the screenshot of the current view includes, but is not limited to, capturing the screenshot in a PNG format, a JPG format, and a GIF format.

In a second step 104, a subsequent view of the application is loaded. The subsequent view may correspond to any change in state of the application from the current state of the application. For example, a transition from a current view of the application to another view of the application in response to a swipe action on a touch screen of the portable communication device may be termed as a change in state of the application. Similarly, User Interface (UI) elements such as, but not limited to, buttons, tabs and links that lead away from the current view cause a change in state of the application.

On detecting one or more actions that cause a change in view of the application, the subsequent view of the application is loaded in the background of the current view. In other words, the subsequent view is downloaded and rendered behind the screenshot of the current view. The subsequent view may be loaded from one or more of a local store associated with the portable communication device and an external server. In the case of loading from the local store, the one or more views associated with the application may be pre-saved on the portable communication device. Here, the one or more views are encapsulated into a package and saved on the portable communication device as will be explained in conjunction with FIG. 6.

In a third step 106, the current view of the application is transitioned to the subsequent view when the subsequent view is substantially loaded. In an example embodiment of the present invention, the current view may transition to the subsequent view only when the subsequent view is completely loaded. In another embodiment of the present invention, the current view may transition to the subsequent view when the subsequent view is partially loaded. For example, if the subsequent view corresponds to a vertically scrollable webpage, the transition from the current view may occur as soon as the portion of the scrollable webpage that fits within the display of the portable communication device is loaded.

When the subsequent view of the application is being loaded in the background, the screenshot of the current view is displayed. When the subsequent view is substantially loaded, the screenshot of the current view is removed and the underlying subsequent view is displayed. This transition from the current view to the subsequent view may involve one or more animations. For example, removal of the current view may be achieved by sliding the screenshot to left or right or by sliding the screenshot to a top or bottom of the display. Further, the current view may fade or disappear to expose the subsequent view. The animations executed during the transition from the current view to the subsequent view may be optionally defined by the user. Thus, a technical effect achieved in the aforesaid transitions is a removal of flickering caused by a blank screen when a subsequent view is loading. It will be apparent to a person skilled in the art that other animations not disclosed herein may also be used to transition from the current view to the subsequent view without deviating from the scope of the invention.

FIG. 2 is an illustration of a schematic representation of an exemplary embodiment of a method of rendering an application view pursuant to the present invention. In this case, the application is a browser and the one or more views associated with the application correspond to one or more web pages of a website. At a first step, a current web page 202 associated with a web page index.html is rendered. The web page 202 may include one or more links such as a link 204 and a link 206 leading to, for example, a web page lorem.html and a web page ipsum.html respectively. At a second step, when a user touches or clicks on the link 204, a screenshot 208 of the current web page 202 of the application is captured and a subsequent view 210 associated with web page lorem.html is loaded and rendered in the background. The screenshot 208 is displayed until the web page 210 associated with lorem.html is substantially loaded. Once the web page 210 is substantially loaded, the screenshot 208 is removed to display the web page 210 by sliding the screenshot 208 to left as shown in the third step.

In FIG. 3, a system 300 for rendering an application view is illustrated. The system 300 includes an imaging module 302 and a processor 304. The imaging module 302 captures a screenshot of a current view of the application. Here, a view of the application is associated with a state of the application as explained in conjunction with FIG. 1. The imaging module 302 may optionally capture the screenshot in, but not limited to, a PNG format, a JPG format, and a GIF format. On capturing the screenshot by the imaging module 302, the processor 304 loads a subsequent view of the application in the background as explained in conjunction with FIG. 1 and FIG. 2. The subsequent view is downloaded and rendered behind the screenshot of the current view. It should be understood that imaging module 302 can be optionally implemented with software running in a processor 304.

FIG. 4 is an illustration of a schematic representation depicting interaction between a processor and a local store to load a current view and a subsequent view of the application. As elucidated in conjunction with FIG. 3, the subsequent view is downloaded from a server and rendered behind the screenshot of the current view. However, the subsequent view may be loaded by the processor 304 from a local store 402 associated with the system 300. At step 404, the processor 304 requests the local store 402 for the subsequent view. At step 406, the local store 402 provides the subsequent view to the processor to render on the system 300.

The processor 304 is configured to transition from the current view to the subsequent view when the subsequent view is substantially loaded. Here, the processor 304 maintains the screenshot of the current view of the application on the display until the subsequent view is substantially loaded. The processor 304 may further be configured to display one or more animations when transitioning from the current view to the subsequent view as explained in conjunction with FIG. 1.

FIG. 5 is an illustration of an exemplary embodiment depicting interaction between the processor 304, the imaging module 302, and the local store 402. As elucidated in conjunction with FIG. 2, the application in this case is a browser. At a step 502, the processor 304 makes a request to the local store 402 for the current web page index.html. Thereafter, at step 504, the current web page index.html is provided to the portable communication device by the local store 402. The web page index.html may include one or more links to one or more web pages such as a web page lorem.html and a web page ipsum.html. At a step 506, when a user touches or clicks on the link associated with lorem.html, a request is sent to the imaging module 302 to capture a screenshot of the current web page index.html. Thereafter, at a step 508, the imaging module 302 captures a snapshot of the current web page index.html. Subsequently, a request for the web page lorem.html is sent by the processor 304 to the local store 402 at step 510. In response to this request, the web page lorem.html is provided by the local store 402 at step 512. The web page lorem.html is loaded and rendered in the background. The snapshot of index.html is displayed until the lorem.html is substantially loaded. Once lorem.html is substantially loaded, the snapshot of index.html is removed and lorem.html is displayed.

FIG. 6 is an illustration of a method of developing a software application for a portable communication device. In a first step 602 of the method a software application developer connects to a server where a development environment is running. Optionally, the server may be hosted on a cloud; “cloud” here relates to contemporary “cloud computing” wherein the Internet is regarded as network, namely a “sky”, with server resources, namely “clouds”, dynamically available within the network, although a user may not necessarily know where the server resources are located which are providing service to the user. Alternatively, the software development environment can run locally in developers' workstation or laptop.

In the second step 604 the software application is created mainly using Hyper Text Markup Language (HTML) code in the development environment. The software application may include one or more views. The one or more views of the software application correspond to one or more states of the software application. For example, a transition from a current interface of the application to another interface of the application in response to a swipe action on a touch screen of the portable communication device may be termed as a change in state of the application. Similarly, User Interface (UI) elements such as, but not limited to, buttons, tabs and links that lead away from the current view may be considered as a change in state of the application.

Each view of the one or more views of the software application may be created independently. For example, a folder structure may be created for the software application and different views of the software applications may be created separately.

After creating the one or more views of the software application using HTML, at a second step 604, the software is implemented so that application testing is initiated. each view of the software application can be converted at a step 606 at the server from the HTML format to a format compatible with the portable communication device. The software application developer may specify the format associated with the portable communication device and accordingly, the HTML code is converted to the specified format at the server. In an embodiment, the HTML code may be converted to a binary format, to a native format, or HTML code might be used as it is, or HTML code can include hybrid of HTML code and some native code, and so forth.

At a step 608, the one or more views of the software application are encapsulated into a package. The package corresponds to an aggregation of software application views that are converted to the specified format at the server. Thereafter, at a step 610, the package is downloaded to the portable communication device. Once the package is downloaded, the package may be saved locally on the portable communication device. On saving the package, a connection between the portable communication device and the server is no longer required. This allows the software application developer to work in an offline mode. The software application may be optionally rendered from the local store thereby avoiding lag associated with retrieving application views from the server when a request for a particular application view is made.

At a step 612, the software application may be tested on the portable communication device. That is, a developer of the software application may now test the software application directly on the portable communication device instead of having to download the converted application onto a computer and then transferring the application to the portable communication device. Thus, the method provides a technical effect of allowing a developer to develop a software application in a fluent manner.

Optionally, after testing the software application at step 612 on the portable communication device, modifications may be made to the software application. Thereafter, the method loops back to step 602 or 604. The modified code is then recompiled at the server and may be directly downloaded onto the portable communication device to be tested. In this way, changes in the software application may be shown to the developer immediately.

Optionally, the developer may be involved in developing more than one software application. In such a situation, the application views associated with each of the software applications may optionally be associated with a unique application identifier (ID) and saved on the server. The developer may provide an application ID, and the associated compiled HTML code package is downloaded onto the portable communication device.

Additionally, the portable communication device may be configured to request the server periodically for any updates to the software application. Alternatively, as a developer uploads an update to the HTML code to the server and the HTML is converted to the specified format, information about the new version of the software application may be sent as a push message to the portable communication device. The developer may then download the new version on the portable communication device and view the updates immediately. In an embodiment the portable communication device can be configured to load code automatically.

FIG. 7 is an illustration of a schematic representation of a method of developing a software application 702 for a portable communication device 704. The software application 702 includes three views 706, 708, and 710 as illustrated in FIG. 7. Each of the views 706, 708, and 710 is created in HTML and uploaded to a server 712. The HTML codes for the views 706, 708 and 710 are respectively 714, 716 and 718. For example, the HTML code 714 (shown below) for the view 706 may be to display a header “Hello World” and a text “Lirum larum . . . ” in a blue text on a white background:

```
<html>
    <head>
    <title> 706 </title>
    </head>
    <body bgcolor=”white” text=”blue”>
    <h1> Hello World </h1>
    Lirum larum ..
    </body>
</html>
```

The server 712 compiles the HTML code and produces a code compatible with the portable communication device 704 for each view. For example, if the portable communication device 704 is an Android™ based smartphone, or other such as iPhone® by Apple® using iPhone operating system, then the HTML code is converted to an Android™ compatible code: “compatible code” refers to either to converting HTML code to binary format or preferably keeping the HTML content as it is, namely no changes are needed thus HTML code can be used as such. The Android™ compatible code may then be downloaded directly to the portable communication device and tested. On testing, if the software application is to be modified, the developer may modify the HTML code and accordingly the Android™ compatible code is modified, or optionally kept as HTML code, and may be downloaded. For example, if the developer decides to modify the view 706 to display “JIPPII” in the header and “Here we go . . . ” as text, then the developer may change the appropriate section of the HTML code 714 as shown below and this change is immediately reflected in the Android compatible code.

```
<html>
    <head>
    <title> 706 </title>
    </head>
    <body bgcolor=”white” text=”blue”>
    <h1> JIPPII </h1>
    Here we go...
    </body>
</html>
```

The user may then immediately preview the application on the portable communication device 704.

Referring to FIG. 8, an application development system 800 for developing a software application for a portable communication device 802 in communication with a server 804 is illustrated. The application development system 800 includes an application development interface 806 for creating the software application in HTML. The software application may include one or more views representing one or more states of the software application. In an embodiment of the present invention, the application development interface 806 may be associated with a computer such as a desktop or a laptop. Optionally, the application development interface 806 may be associated with the portable communication device 802. A developer may use the application development interface 806 for creating the software application. On creating the software application, a first transceiver (not shown in FIG. 8) may be used to upload the one or more views of the software application to the server 804.

The server 804 includes a conversion module 808 for converting each view of the one or more views of the software application to a specified format compatible with the portable communication device 802. Optionally, the conversion module 808 can convert the one or more views into a binary format. On converting the one or more views to a format compatible with the portable communication device 802, an encapsulation module 810 associated with the server 804 encapsulates the one or more views of the software application into a package as explained in conjunction with FIG. 6.

Optionally, the server 804 can be configured so that no HTML to binary conversions are made but HTML code is packaged, or wrapped, in an application which is sent to communication device 802. According to this option, HTML code is in “HTML” format in a communication device 802 and is rendered locally. “Conversion” can optionally refer to said packaging or wrapping of the HTML documents in an application or to adding metadata such as application structure information or configuration of desired behaviour of the native mobile environment/application. Metadata can refer to parameters related to configuration or structure of the application. Additionally certain elements related to look and feel of the application could be configured using metadata.

A second transceiver (not shown in FIG. 8) associated with the portable communication device 802 may then download the package from the server 804 to the portable communication device 802. The package may then be saved in a memory 812 associated with the portable communication device 802. Moreover, the portable communication device 802 further includes a rendering module 814 for rendering the software application from the package on the portable communication device. Once rendered, the software application may be tested on portable communication device 802 using a testing module 816.

In an embodiment of the present invention, the portable communication device 802 may include a preview application 902 for previewing the software application on the portable communication device 802 as illustrated in FIG. 9. The preview application 902 may be launched, for example, by tapping the preview application 902 with a finger. On launching the preview application 902, an input field 904 is presented to the user. The user may then enter an application ID in the input field 904 and the corresponding native code corresponding to that application ID is downloaded and rendered on the portable communication device 802. A view of the software application such as a view 906 may be rendered. In another embodiment of the present invention, one or more icons corresponding to one or more software applications associated with the user may be displayed by the preview application 902. The user may select one of the icons to download the corresponding native code to the portable communication device 802. Thus, the user may directly preview the software application on the portable communication device 802 using the preview application 902. In an other embodiment user can enter manually (with user interface of the portable communication device) Internet Protocol (IP) address of the computer 804 where the development environment is installed and the development environment sends current project (software application under development) to the portable communication device 802. According to further embodiment the portable communication device 802 can scan network to find automatically development environment.

Optionally, the software development environment can run in a workstation or a laptop 1002 of a developer instead of a server in a cloud as illustrated in FIG. 10. The development environment running in the workstation or the laptop 1002 can be configured in such a manner that the mobile communication device 802 can open a connection to the environment provided on the laptop 1002 via wireless communication, for example using Wi-Fi connectivity, BlueTooth connectivity or for example via local area network, for example as shown in a step S10.1. The connection can be formed using any terminal control protocol (TCP) transport or the connection can be formed using, for example, IP Socket connection or web socket connection. Opening of a socket thereby established between the workstation, for example a server, and the mobile communication device, namely client, 802 can be referred as “forming socket pairs”. Optionally, the development environment is configured to monitor any changes in the HTML content of the application under development, namely at a step S10.2. In case of a change in one or more files being detected by the development environment, the changed file is sent automatically over the connection to the communication device 802, namely at a step S10.3. This is beneficial since the application under development can be large and updating all files can take a long time. In addition, if the connection is formed, for example, over a cellular network, an upload time from the workstation, for example laptop, 1002 can take a long time as well as use an extensive amount of network resources. Additionally, in case of concurrently serving multiple developers, it is beneficial to update only that file, or those files, which have been modified. The mobile communication device 802 updates the file, or files, automatically in a step S10.4. Updating can refer to replacement of an old file if it exists or to creation of a new file or a new folder in the preview application file system. In a step S10.5, the mobile application is automatically updated and a view thereby provided is refreshed and rendered. Optionally, the development environment running in cloud can be configured to accept connections from communication devices to enable similar functionality as in local environment example above.

Although embodiments of the invention are described in the foregoing, it will be appreciated that the present invention is also susceptible to being implemented in a software product recorded on machine readable data storage media, characterized in that said software product is executable upon computing hardware for implementing the aforesaid methods.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A method of rendering an application view on a portable communication device, the method including:
capturing a screenshot of a current view of said application; and
loading a subsequent view of the application;
characterized by,
transitioning from said current view to said subsequent view when the subsequent view is substantially loaded, wherein said screenshot of the current view of the application is displayed until the subsequent view is substantially loaded.

2. A method as claimed in claim 1, characterized in that said method further includes displaying at least one animation when transitioning from the current view of the software application to a subsequent view of the software application.

3. A method as claimed in claim 1, characterized in that said method includes loading the subsequent view of the application comprises at least one of loading the subsequent view from a local storage and/or loading the subsequent view from an external server.

4. A method as claimed in claim 1, characterized in that, when the subsequent view corresponds to a vertically scrollable webpage, said method includes transitioning from the current view occur as soon as the portion of the scrollable webpage fitting within the display of the portable communication device is loaded.

5. A method as claimed in claim 1, characterized in that said method includes presenting the current view to fade or disappear to expose the subsequent view.

6. A system (300) for rendering an application view, the system including:
an imaging module (302) for capturing a screenshot of a current view of said application; and
a processor (304) for loading a subsequent view of the application, characterized by, said processor handling transitioning from said current view to said subsequent view when the subsequent view is substantially loaded, wherein said screenshot of the current view of the application is displayed until the subsequent view is substantially loaded.

7. A software product recorded on machine readable data storage media, characterized in that said software product is executable upon computing hardware for implementing a method as claimed in claim 1.
